(19) United States
(12) Patent Application Publication
(10) Pub. No.: US 2005/0071268 A1
(43) Pub. Date: Mar. 31, 2005

(54) Method of making payments by cash over a network

(76) Inventor: Robert Gibson Riddett JR., Lawrenceville, GA (US)

Correspondence Address: REINHART BOERNER VAN DEUREN S.C.;ATTN: LINDA GABRIEL, DOCKET COORDINATOR, 1000 NORTH WATER STREET, SUITE 2100, MILWAUKEE, WI, 53202, US

(21) Appl. No.: 09/798,796

(22) Filed: Mar. 1, 2001

Related U.S. Application Data
(60) Provisional application No. 60/072,828, filed on Jan. 28, 1998.
(60) Provisional application No. 60/186,038, filed on Mar. 1, 2000.

(51) Int. Cl. G06F 17/60

(52) U.S. Cl. 705/40; 705/35

(57) ABSTRACT

A method by which a consumer can establish an account which available over the Internet and through which the consumer can make purchases or authorize payments is described. In accordance with the inventive method, a consumer who does not have a credit card is able to use cash to establish and maintain the account, from which on-line purchases can be made. Alternatively, checks or wire transfers can be authorized from the account. In an alternative embodiment, the consumer can protect his privacy by authorizing account transfers, payments, and the like, in which his personal information is unavailable to those with whom he deals.

### CROSS-REFERENCE TO RELATED APPLICATIONS

The present application is a continuation of U.S. provisional application Ser. No. 60/072,828 entitled “METHOD OF MAKING CASH PAYMENTS OVER A NETWORK” which was filed on Mar. 1, 2000.

### BACKGROUND OF THE INVENTION

The present invention relates to a method for making cash payments over a computer network, such as the Internet by persons who do not, necessarily have access to a credit card.

The Internet is becoming one of the fastest growing shopping marketplaces in the world. Large Internet retailers such as Amazon.com, eBay, Barnes and Noble.com, and numerous others, allow consumers, accessing their World Wide Web sites (“URLs”) to place orders for goods and services. These transactions are primarily paid for by consumers using their existing credit cards with the merchandise delivered electronically, by mail or by courier service to their home or other location. This process is advantageous to the retailer, as its goods are available worldwide without the need to advertise throughout the world. In addition, the benefit to the retailer of dealing with such established companies as American Express, Diners Club, Discover, MasterCard, and Visa enables them to ship items substantially without the attendant risk of dealing with the credit worthiness of their customers, and without any time delays, check clearing, or other issues.

In addition, the use of the Internet to make retail purchases by a consumer generally allows the consumer to deal with those who have lower operating costs, and lower selling prices than traditional retailers; it provides the consumer with a greater variety of choice than many traditional retailers, particularly those in rural settings; and it allows the consumer to “shop” at a variety of locales, without having to travel to them.

However, the process does not currently allow a consumer who does not have a credit card or is not credit worthy to place orders as there is no mechanism for paying with cash or by using a check.

Thus, while the Internet provides consumers with extensive ability to place orders for merchandise throughout the world on an electronic basis, the benefit of access to a worldwide marketplace are not available to those who either do not have access to a credit card, or to those who do not want to use their credit card over the Internet for such reasons as security or privacy. Similarly, other groups of consumers, e.g., those under the age of 18 who cannot qualify for a credit card, those who would rather pay by check and those who would rather pay by cash, have heretofore been excluded from use of the Internet for making purchases.

### SUMMARY OF THE INVENTION

In accordance with the present invention, a method is described which allows consumers to place orders and “pay cash” for these purchases. In accordance with the present invention, a process is described which will provide each of the foregoing, previously excluded groups, access to Internet purchase capability.

The inventive process uses the existing commercial banking system, an interactive Web site, and a unique numbering and transaction control system, in various embodiments to provide a highly adaptable, consumer and merchant friendly solution for “non-credit card payment” on the Internet as described herein.

### BRIEF DESCRIPTION OF THE DRAWING

In the Drawing:

FIG. 1 is a flow chart which illustrates how a consumer who has a “PaymentByCash” account can make a direct purchase from a merchant who already has an established account with the provider of the present inventive services;

FIG. 2 is a continuation of the process described in FIG. 1; and

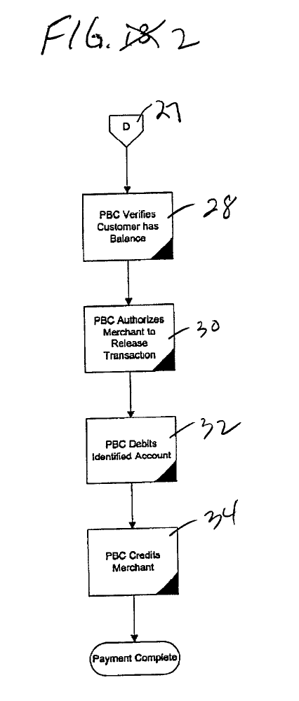

FIG. 3 is a flow chart which illustrates how a consumer makes a deposit into his account;

FIG. 4 is a continuation of the method shown in FIGS. 3 and 5 showing how a consumer confirms that he has deposited cash (or cash equivalent) into the “PaymentByCash” account;

FIG. 5 is a continuation of the method shown in FIG. 3 illustrating how a new consumer becomes a customer of the provider of the inventive services, and it illustrates how the consumer is directed to a local member bank to make a deposit into the “PaymentByCash” account.

FIG. 6 is a flow chart which illustrates how a consumer can contact the provider of the present inventive services to establish an account;

FIG. 7 is a flow chart which illustrates an alternative method by which the provider of the inventive method can make a payment to a merchant in accordance with instructions from a consumer;

FIG. 8 is a flow chart which illustrates an alternative embodiment of the present invention wherein a consumer can make a purchase anonymously from a merchant.

FIG. 9 is a flow chart which illustrates one method by which the provider of the inventive method can make a check payment in accordance with instructions from a consumer;

FIG. 10 is a flow chart which illustrates an alternative method by which a consumer can establish a “PaymentByCash” account, without need to go to a member bank;

FIG. 11 is a flow chart which illustrates how a consumer can establish, or add to, an account by debiting an existing checking account;

FIG. 12 is a flow chart which illustrates an alternative method for a consumer who has a credit card, to establish an account in which his individual identity would be anonymous to the retailer;

FIG. 13 is a flow chart which illustrates how the provider of the services, in accordance with the present inventive method, advises the consumer of the availability of funds for making Internet purchases;

FIG. 14 is a flow chart which illustrates how a consumer can consolidate account balances into a single account;

### DESCRIPTION OF THE PREFERRED EMBODIMENTS

As illustrated in the various FIGS. of the accompanying drawing, the present inventive process is described as follows. A consumer contacts a provider of the present inventive services. One such provider is referred to herein as “PaymentByCash.com” (or “PBC”) to illustrate that the provider of the services can be contacted via the Internet either directly or via a link from the web page of an Internet retailer. The consumer decides if he/she wants the purchase to be anonymous or not. If the customer desires anonymity, then no consumer information is entered into the “PaymentByCash.com” system and an anonymous transaction, referred to herein as a “NumberedSwissAccount.com” transaction is established. If anonymity is not desired then certain unique consumer information is entered to allow for security identification at a later date. The consumer may also choose to prepay with cash by acquiring a “NumberedSwissAccount.com” identifier card at a local retailer or bank.

The consumer enters specific location information (e.g., his zip code) showing where he wants to make his “cash payment”. The consumer is provided the ability to create a new Internet cash payment transaction or to add money to an existing cash payment transaction or a “NumberedSwissAccount.com” transaction. Then, the consumer decides how much cash he desires to make available for payment via the Internet and enters this amount into the “PaymentByCash.com” web page.

If the consumer has accumulated enough “cash” for his proposed transaction, he proceeds to generate the transaction identifier. PBC creates a unique cash payment transaction account for this consumer and generates a Commercial Bank Checking Account Deposit Slip for credit to a PBC “Clearing” Account and a consumer control ticket for reconciliation later in the process. This deposit slip is identical to normal Commercial Bank deposit slips except that a unique PBC transaction identifier is printed on the deposit ticket.

The consumer then takes this deposit ticket to the designated Commercial Branch nearest his location with his cash or check to be used for payment, and the Commercial Bank accepts the deposit in it's ordinary course of business and generates a “deposit receipt” for the consumer. This deposit receipt will contain specific unique information necessary for the Bank and PBC to track this specific deposit throughout the banking system.

The Commercial Bank credits PBC's account and returns the unique deposit ticket to PBC in the ordinary course of business. The Commercial Bank also provides PBC with on-line access to PBC for verifying deposits.

The consumer returns to his/her Internet access point, logs onto the “PaymentByCash.com” web site and recalls the transaction using the consumer control ticket which he/she started.

The consumer then uses the Commercial Bank “deposit receipt” to answer specific security information which is used to confirm the deposit has taken place. “PaymentByCash.com” then generates a transaction identifiaction number and allows the consumer to print out the specific information necessary for his Internet purchase.

The consumer logs onto the Internet retailer's site and proceeds with placing his/her order. At the end of the order process, the consumer is allowed by the retailer to choose “PaymentByCash.com” as a payment option and enters the transaction identifier received by him.

The Internet retailer sends a transaction verification request to PBC for verification. Once verified, the Internet Retailer releases the merchandise or service to the consumer.

PBC forwards funds electronically to the Internet Retailer via the appropriate pre-agreed methodology. (Check, ACH, Bank transfer, wire transfer or other similar financial clearing process).

While the present inventive process uses the Commercial Banking system, it is unique in the fact it combines the existing Commercial Bank checking account process for handling cash deposits with a unique transaction identification process, an Internet web site that controls all phases of the process to ensure security, anonymity, and funds flow. The unique control process of custom printed “deposit tickets”, deposit receipts, transaction reconciliation, transaction identifiers and Internet merchant settlement makes this process unlike anything existing today.

### A PBC Transaction

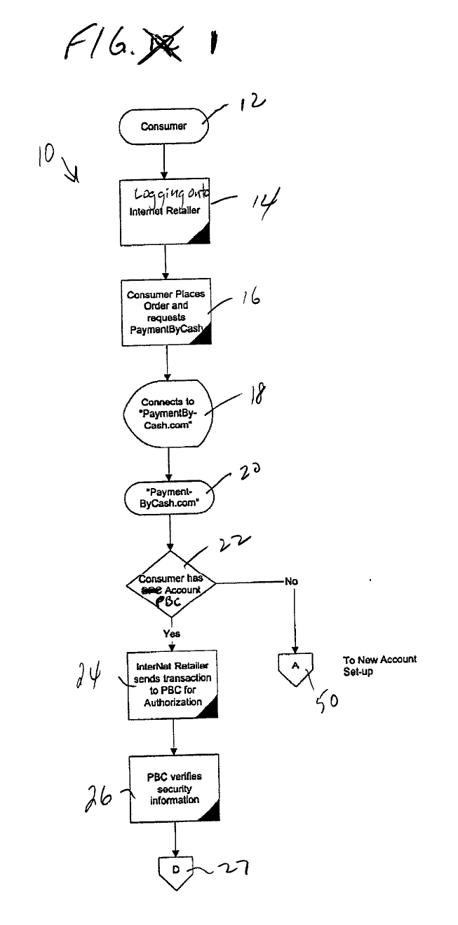

Referring now to the specifics of the present invention, and with particular reference to FIG. 1, the method of conducting a transaction 10 in accordance with the present invention, is depicted. In accordance with the method, a Consumer 12 (who has a PBC Account) commences a transaction 10 by logging onto a web site of an Internet retailer, as shown at 14. The Consumer can place an order, requesting that payment be made through a “PaymentByCash” account, as depicted at step 16. The Consumer can advise the Internet Retailer that the Consumer has a PBC account, in which case the Internet Retailer can connect to the web site of a PBC provider (referred to herein as “PaymentByCash.com”), as shown at step 18, and the Internet Retailer will connect to the PaymentByCash.com web site, as shown in step 20, to determine if the Consumer has a valid account. In this respect, the transaction is similar to a consumer logging onto a web site of any Internet Retailer and seeking to pay for a purchase by using a credit card, in which case a validity check is made of the credit card prior to issuing confirmation of the order.

Once connected to the PaymentByCash.com web site, the Internet Retailer will determine whether the Consumer already has a PBC account (“a PBC Account”) at step 22. If it is determined that the Consumer has an existing, valid PBC Account, then processing continues at step 24, in that the Internet Retailer sends a transaction to PBC which verifies that the security information provided to the Internet Retailer (step 26) is valid, and that the Consumer has an adequate balance in his PBC Account to pay for the purchase (step 28). If the Consumer's PBC Account has an adequate balance, then PBC will authorize the Internet Retailer to conclude the transaction, at step 30. PBC will then debit the Consumer's PBC Account (step 32), and will credit the Internet Retailer's account by the amount of the purchase, thereby completing the transaction, at step 36.

### Establishment of a PBC Account

Prior to using a PBC Account, the Consumer 12, must, of course, have one. As set forth below, various the steps 30 by which a Consumer 12 can establish a PBC Account are shown.

First, the Consumer 12 can physically go to a local bank affiliated with PBC, bringing cash, as shown at step 34. The Consumer 12 will make a deposit into a PBC Account and receive a deposit slip which has instructions, and appropriate security codes which enable the Consumer to gain access to a PBC Account, as shown at step 34. The Consumer then logs onto the Internet, and connects to the PaymentByCash.com web site for additional actions, to be explained hereinafter.

As an alternative to going to a Local Bank (step 32) the Consumer 12 can initiate the setup of a PBC Account by first contacting PBC at its web site, as shown at step 36, or, alternatively, the Consumer can first go to the web site of an Internet Retailer who is associated with PBC, as shown at step 38. As yet another alternative, the Consumer 12 can set up an anonymous PBC Account by going to a Local Bank or Retailer with cash, as shown at step 40, and purchasing an anonymous, pre-paid “NumberedSwissAccount.com” card, as shown at step 42.

Following any of the foregoing steps (e.g., steps 34, 36, 38, or 42) the Consumer has the ability to log onto the PBC web site, as shown at step 44. Once the Consumer 12 has logged onto the PBC web site, it is determined, at step 48, whether the Consumer 12 has already set up a PBC Account ID. If the Consumer 12 is one who has simply first gone to the PBC web site (step 46) without having been directed there by step 44, then the Consumer will not have a PBC Account, so the Consumer 12 will be directed to establish a new PBC Account at 50.

### Depositing Funds into a PBC Account

If the Consumer 12 who has gone to the PBC web site (step 46) already has a PBC Account, the Consumer 12 will have to “deposit” funds into his PBC Account for it to be useable. To do that the Consumer 12 logs onto the PBC Account by entering his username and password, or similarly identifying himself, at step 52. If the Consumer 12 has a “PBC deposit slip” from a bank (See, step 34), or a pre-paid card (See, step 42), then the Consumer 12 is ready to deposit funds into his PBC Account, up to the amount of the PBC deposit slip or the pre-paid amount on his card. While the Consumer 12 can deposit the full amount available to him, he does not have to do so. Accordingly, at step 54 the Consumer 12 tells the system that he either does, or does not, wish to deposit funds into his PBC Account.

If the Consumer 12 is ready to deposit funds, as indicated at 56, then he is directed to proceed to the steps 60 relating to the deposit of funds into his PBC Account.

### Crediting Funds to a PBC Account

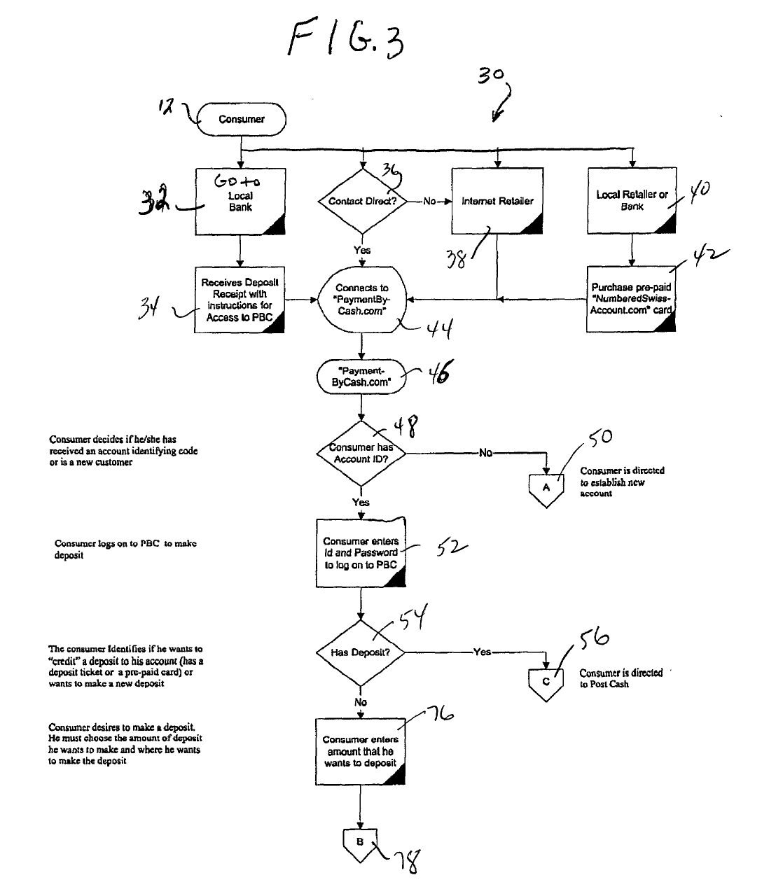

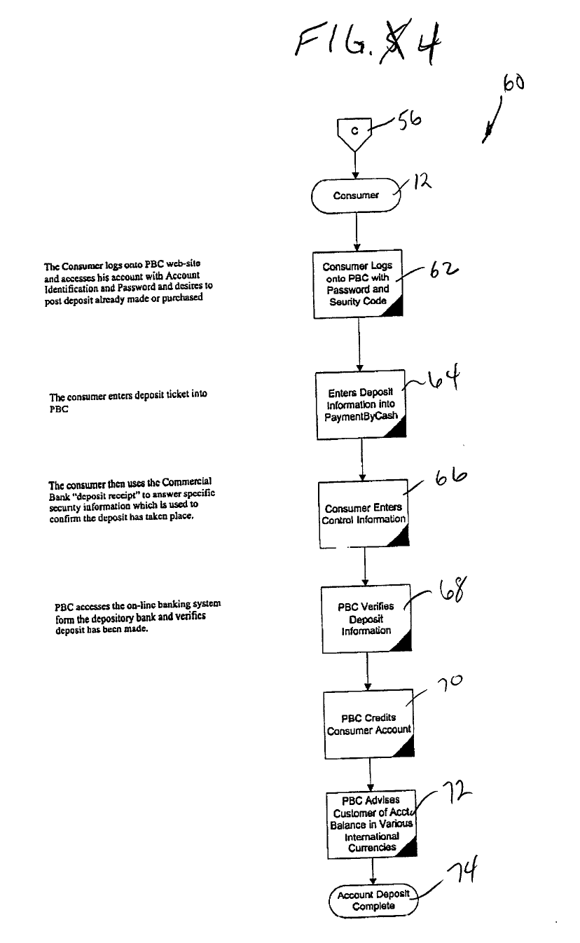

With reference to FIGS. 3 and 4, the steps involving the crediting of funds to a PBC Account are shown. These steps 60 relate to a Consumer 12 who has already brought funds to a bank (See, FIG. 3, step 32), or who already has a pre-paid card (See, FIG. 3, step 42) and now wishes to credit his PBC Account with some, or all, of the funds. In particular, a Consumer 12 who has been directed to the deposit steps 60 starting at 56, will provide appropriate security and identification information to the system, as associated with a particular PBC Account, to which the Consumer has access.

The Consumer 12 enters the information (from the deposit slip or pre-paid card), as shown at step 64. This may include certain “Control Information” from the deposit slip which enables PBC to associate the funds being “credited” with actual funds received by a PBC receiving bank (See, step 32). After the Control Information is entered, at step 66, PBC can verify the deposit information provided by the Consumer 12, with the bank, and if the bank verifies the Control Information, i.e., it confirms that the Consumer 12 has actually made a cash deposit, then PBC will credit the Consumer's PBC Account, at step 70. Next, PBC will advise the Consumer 12 of the available PBC Account balance in various currencies, at step 72. This may be displayed in the browser of the Consumer 12, or it may be printed out, thereby concluding the steps 60 needed to credit a PBC Account with funds previously deposited in a bank (FIG. 3, step 32) or paid for a pre-paid card (FIG. 3, step 42) to the Consumer's PBC Account, as shown at step 74.

### Depositing Funds into a PBC Account

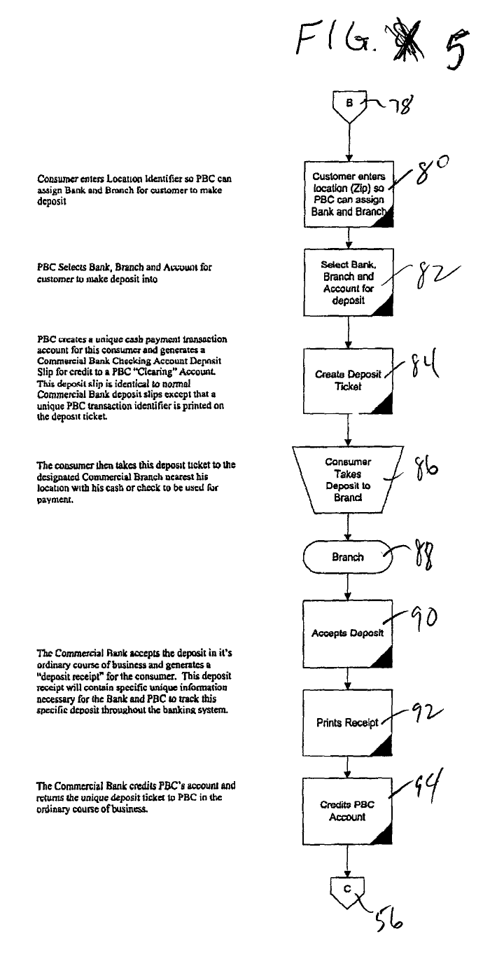

With reference to FIGS. 3 and 5, the steps involving the crediting new funds into a PBC Account are explained. It is possible that a Consumer 12 who wishes to credit a PBC Account has not already made a deposit at a bank (FIG. 3, step 32) or purchased a pre-paid card (FIG. 3, step 42). By way of example, a Consumer who is traveling might wish to place an order over the Internet, and may not know where a local PBC receiving bank is located. In such case, the Consumer 12 will be directed, at step 54 (FIG. 3) to enter the amount which he wishes credited to his PBC Account (FIG. 3, step 76), and he will be directed, at 78, to provide additional information.

With reference to FIG. 5, the Consumer 12 is asked for location information, which may be in the form of a zip code, or latitude-longitude information (from a GPS display, for example), at step 80. From this information, PBC will determine the closest available PBC receiving bank branch to which the Consumer 12 can go to make a cash deposit, at 82. PBC will create a PBC Deposit Ticket (similar to a bank deposit slip), at 84, with appropriate information for the Consumer to take to the bank branch so that the Consumer 12 can take the Deposit Ticket to the slected bank branch (steps 86, 88), where the Consumer 12 will make the deposit into PBC's bank account. The PBC receiving bank will accept the deposit (step 90), print a receipt for the Consumer 12 (step 92), and credit PBC's bank account (step 94). A Deposit Ticket can then be provided to the Consumer 12 who can then use it in the manner heretofore discussed with reference to FIG. 4 (steps 56-74). However, as the Deposit Ticket which was printed to at step 84 can already contain information about the Consumer's PBC Account, the PBC receiving bank could also automatically credit the Consumer's PBC Account, without need for the Consumer 12 to log onto the PBC web site.

### New PBC Account Setup

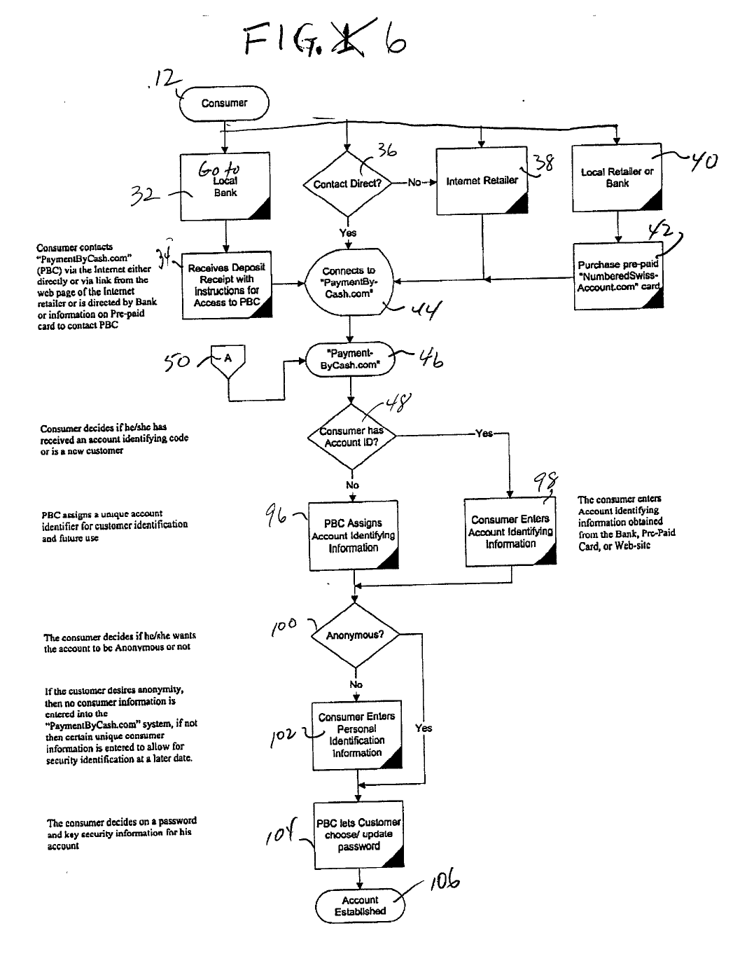

If the Consumer 12 has reached location 50 (See, FIGS. 1 and 3), it means that the Consumer 12 must set up a new PBC Account. With reference to FIG. 6, in such case, the Consumer 12 will go from step 48 (See, FIGS. 3 and 6) to either step 96, where PBC will assign account identifying information to the Consumer 12, as the Consumer 12 did not have such information, or, alternatively, where the Consumer 12 had account identifying information, the Consumer 12 will enter that information (step 98). The Consumer 12 will decide, at step 100, whether an “anonymous” PBC Account is desired. If so, the Consumer 12 will enter personal identification information for his PBC Account, at step 102. Alternatively, no such identifying information will be supplied by the Consumer 12, which will allow the Consumer 12 to make “anonymous” purchases with his PBC Account, thereby maintaining his privacy, but at the potential risk of losing access to his PBC Account funds if he should lose his account access information. PBC will then allow the Consumer 12 to select or update his access information (e.g., username and password), thereby completing the establishment of the PBC Account, as shown at 106.

### Merchant Payments Using PBC Accounts

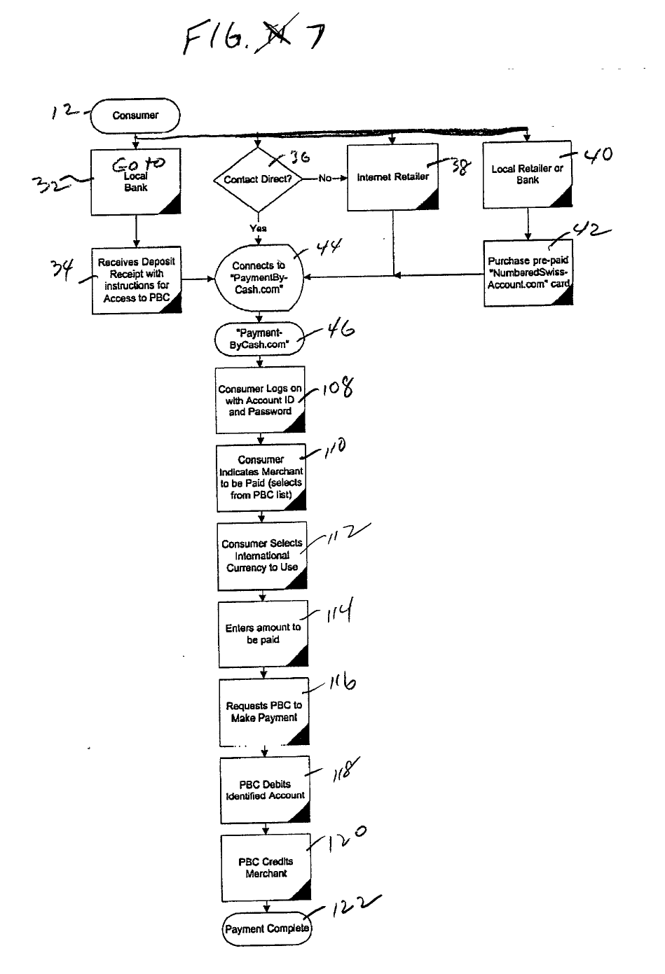

With reference to FIG. 7, a Consumer 12 who has a PBC Account can pay Merchants who also have PBC Account by using his PBC Account by logging onto the PBC web site using his Account ID and password (step 108). He then identifies the Merchant to be paid, which may be selected from a PBC supplied list (step 110); he selects the appropriate international currency to be used (step 112); the amount to be paid to the Merchant (step 114); and confirms that he wants PBC to make the payment (step 116). PBC will then debit the funds from the Consumer's PBC Account (step 118), and credit funds to the Merchant's PBC Account (step 120), completing the Merchant payment steps, at 122.

### “Wire” Transfers from PBC Account

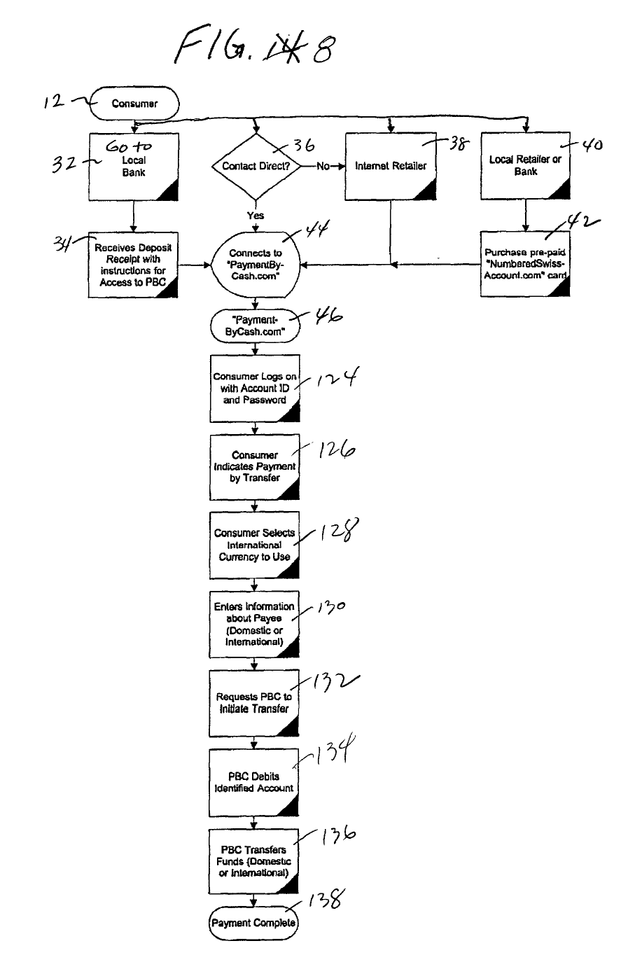

With reference to FIG. 8, a Consumer 12 who has a PBC Account can make a “wire” transfer to someone who does not have a PBC Account by logging onto the PBC web site using his Account ID and password (step 124). He then indicates that he wants to initiate a payment by “wire” transfer (step 126); he selects the appropriate international currency to be used (step 128); he enters information about the Payee (step 130), who can be domestic or international; and he requests PBC to initiate the transfer (step 132). PBC will then debit the funds from the Consumer's PBC Account (step 134), and initiate the “wire” transfer to the Payee (step 136), thereby completing the “wire” transfer steps, at 138.

### Check Transfers from PBC Account

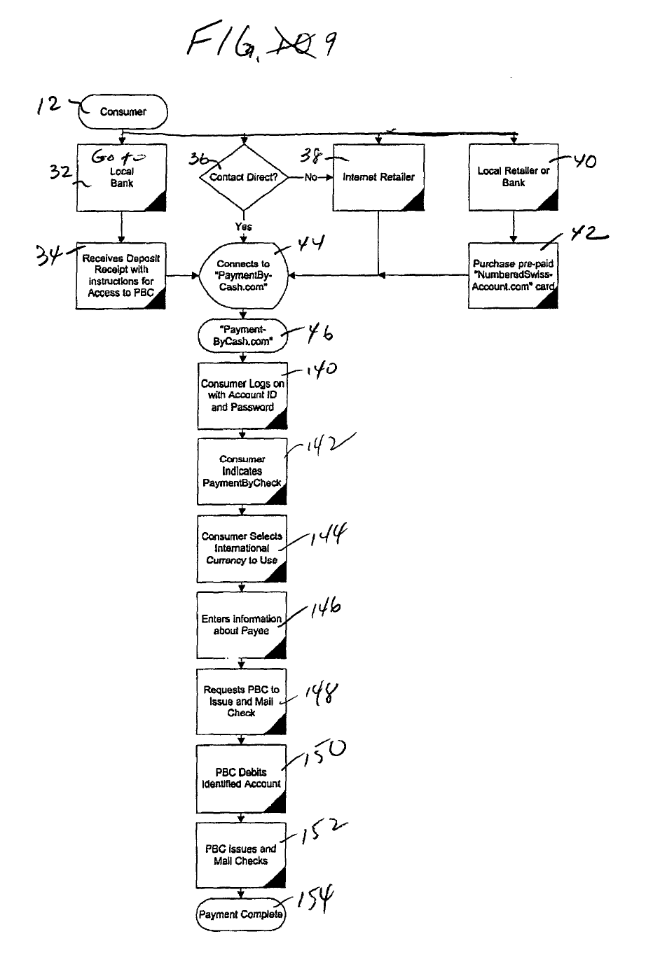

With reference to FIG. 9, a Consumer 12 who has a PBC Account can make a payment by check transfer to someone by logging onto the PBC web site using his Account ID and password (step 140). He then indicates that he wants to initiate a payment by check (step 142); he selects the appropriate international currency to be used (step 144); he enters information about the Payee (step 146), who can be domestic or international; and he requests PBC to initiate the issuance and mailing of a check to the Payee (step 148). PBC will then debit the funds from the Consumer's PBC Account (step 150), and issue and mail a check to the Payee (step 152), thereby completing the “wire” transfer steps, at 154.

### Adding Funds to PBC Account by Check

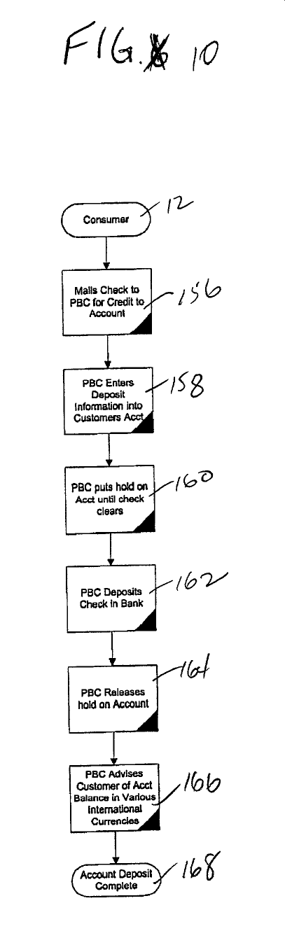

With reference to FIG. 10, a Consumer 12 may wish to add funds to an established PBC Account by mailing a check to PBC (step 156), in which case PBC will enter the deposit information in the Consumer's PBC Account (step 158), placing access to the funds credited on “hold” to allow time for the Consumer's check to be deposited and to clear (step 160). PBC deposits the check into its account (step 162), and releases the funds to the Consumer's PBC Account (step 164), after waiting an appropriate time period, as established by PBC's own bank and/or its check guaranty company. When the Consumer's check has cleared, PBC can send the Consumer 12 an e-mail message to advise the Consumer, and it can update the available credit in the Consumer's PBC Account (step 168).

### Adding Funds to PBC Account by ACH Debit

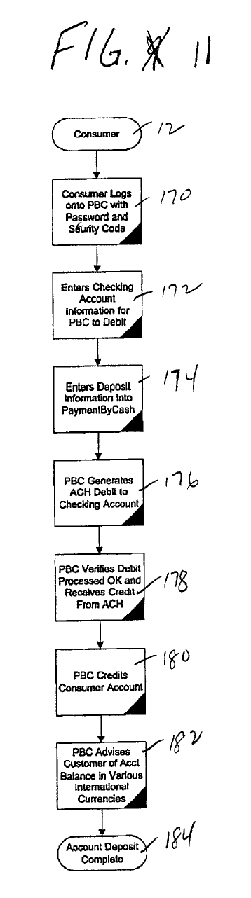

With reference to FIG. 11, a Consumer 12 may wish to add funds to an established PBC Account by debit from an ACH account. The Consumer 12 will log onto PBC using his account access information (step 170). Next, the Consumer 12 will enter the information (Bank ABA number and checking account number) relating to the checking account which PBC is to debit (step 172), along with the information relating to the amount to be deposited into the Consumer's PBC Account (step 174). PBC will verify that the debit has been processed through the Consumer's bank, receiving credit from ACH (step 178), at which point PBC will credit the Consumer's PBC Account (step 180), and then PBC will update the available credit in the Consumer's PBC Account (step 182), which can be done in various international currencies, thereby completing the debit deposit into the Consumer's PBC Account (at step 184).

### Adding Funds to PBC Account by Credit Card

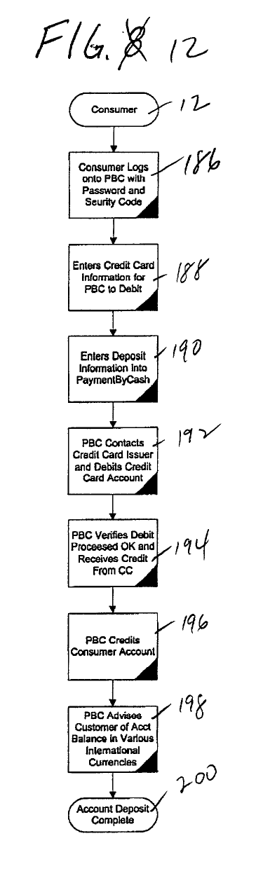

With reference to FIG. 12, a Consumer 12 may wish to add funds to an established PBC Account by charging the deposit to a credit card account. The Consumer 12 will log onto PBC using his account access information (step 186). Next, the Consumer 12 will enter the credit card information (account number, expiration date, account holder, etc.) relating to the credit card account which PBC is to charge (step 188), along with the information relating to the amount to be deposited into the Consumer's PBC Account (step 190). PBC will process the credit card information (step 192) and verify that the credit card “slip” has been successfully processed through the Consumer's credit card company, receiving credit from them (step 194), at which point PBC will credit the Consumer's PBC Account (step 196), and then PBC will update the available credit in the Consumer's PBC Account (step 198), which can be done in various international currencies, thereby completing the debit deposit into the Consumer's PBC Account (at step 200).

### Adding Funds to PBC Account by Bank Advice of Deposit

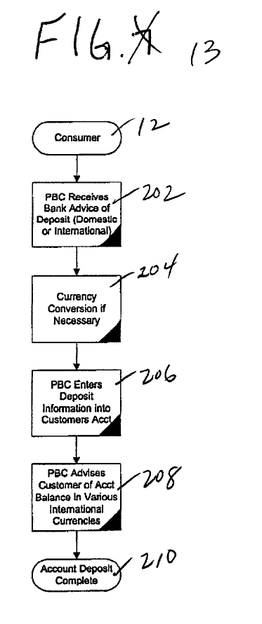

With reference to FIG. 13, a Consumer 12 may wish to add funds to an established PBC Account by Bank Advice of Deposit. In such case, the Consumer 12 will make arrangements for a bank to issue a Bank Advice of Deposit to PBC. When PBC receives the Bank Advice of Deposit (at step 202) and performs any necessary currency conversion (step 204), PBC will enter the deposit information in the Consumer's PBC Account (step 206), and then PBC will advise the Consumer 12, e.g., by an e-mail message or by updating the Consumer's information at the PBC web site, which can be made available to the Consumer 12 in a number of international currencies (step 208), thereby completing the deposit to the Consumer's PBC Account (step 210).

### Consolidation of PBC Accounts

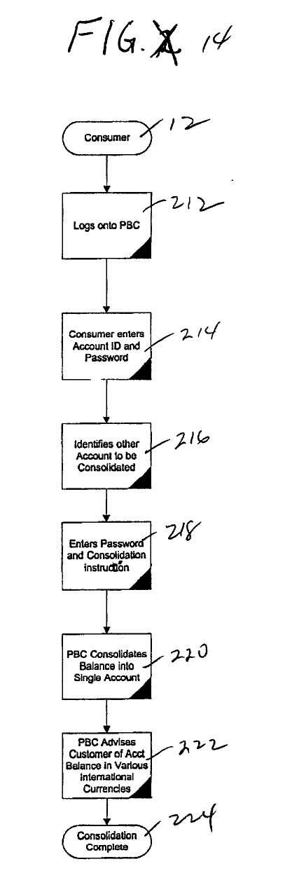

With reference to FIG. 14, a Consumer 12 may wish to add funds to an established PBC Account by moving them from another PBC Account, thereby consolidating the accounts, in whole or in part. The Consumer 12 will log onto PBC (step 212), and he will enter the account access information for the first PBC Account (step 214). Next, the Consumer 12 will enter the access information for the second PBC Account (step 216). By entering appropriate consolidation instructions (at step 218), the Consumer 12 will authorize PBC to perform an account consolidation (step 220), and PBC will consolidate the balances in the two accounts (in whole or in part). Next, PBC will update the available credit in the Consumer's PBC Accounts (step 222), one of which may cease to exist, in various international currencies, thereby completing the account consolidation process (at step 224).

1. A method for providing an on-line service for making payments on behalf of an account holder comprising the steps of:
(a) establishing an account and associating it with an account holder;
(b) providing said account holder with account access information, whereby said account holder can access said account to authorize said on-line service to conduct transactions thereto and therefrom;
(c) providing said account holder with a method for making deposits into said on-line account without use of a credit card or a debit card, whereby said account holder can deposit funds into said on-line account; and
(d) providing fund disbursement means for disbursing available funds in said account as directed by said account holder.

2. The method of claim 1 whereby said step of establishing an account and associating it with an account holder is accomplished by the steps of:
(a) providing a prospective account holder with banking information whereby said prospective account holder can make a cash deposit into a bank having a relationship with said on-line service;
(b) providing said prospective account holder with a deposit slip including information relating to a cash deposit made at said bank, said deposit slip including information which said prospective account holder can use in connection with a web site to establish an on-line account and credit funds from said deposit slip therein; and
(c) providing said account holder with a web site at which said prospective account holder can open an account and credit said account with funds from said deposit slip.

3. The method of claim 1 whereby said step of establishing an account and associating it with an account holder is accomplished by the steps of:
(a) providing a prospective account holder with a retail location at which said prospective account holder can obtain a pre-paid card representative of an amount to be made available to said prospective account holder, said pre-paid card having unique information associated therewith which said prospective account holder can use in connection with a web site to establish an on-line account and credit funds from said pre-paid account therein; and
(b) providing said account holder with a web site at which said prospective account holder can open an account and credit said account with funds from said pre-paid account.

4. The method of claim 1 wherein said step of providing said account holder with a method for making deposits into said on-line account without use of a credit card or a debit card, whereby said account holder can deposit funds into said on-line account comprises the step of providing said account bolder with means for sending funds to said on-line service by check.

5. The method of claim 1 wherein said step of providing said account holder with a method for making deposits into said on-line account without use of a credit card or a debit card, comprises the step of providing said account holder with means for consolidating funds from multiple accounts.

6. The method of claim 1 wherein said step of providing fund disbursement means for disbursing available funds in said account as directed by said account holder comprises the step of providing means for crediting a merchant account with funds from said account holder's account as directed by said account holder.

7. The method of claim 1 wherein said step of providing fund disbursement means for disbursing available funds in said account as directed by said account holder comprises the step of providing means for directing said on-line service to issue a check to a named payee.

8. The method of claim 1 wherein said step of providing fund disbursement means for disbursing available funds in said account as directed by said account holder comprises the step of providing means for sending a wire transfer to a bank account from said account holder's account as directed by said account holder.
